(19) United States
(12) Patent Application Publication
(10) Pub. No.: US 2026/0088836 A1
(43) Pub. Date: Mar. 26, 2026

(54) COUPLING-SHARED ANTENNA SYSTEM

(71) Applicant: QUALCOMM Incorporated, San Diego, CA (US)

(72) Inventors: Yi-Hsiang KUNG, Taipei City (TW); Chao-Kuei CHANG, Taipei City (TW)

(21) Appl. No.: 18/894,428

(22) Filed: Sep. 24, 2024

(51) Int. Cl. H04B 1/00; H01Q 1/28; H04B 7/185

(52) U.S. Cl. CPC H04B 1/006; H01Q 1/288; H04B 7/18502

(57) ABSTRACT

A system for terrestrial and satellite communication includes: at least one antenna; an impedance element electrically coupled to a satellite transceiver; and a first switch electrically coupled to the at least one antenna and configured to selectively electrically couple the at least one antenna to one of (1) the satellite transceiver via the impedance element and (2) a terrestrial transceiver; wherein: the at least one antenna has an at least one antenna impedance that is tuned for the at least one antenna to operate at a first frequency band for the terrestrial transceiver; and the impedance element is configured to tune the at least one antenna impedance for the at least one antenna to operate at a second frequency band, different from the first frequency band, for the satellite transceiver.

### BACKGROUND

At present, there is a growing demand for both terrestrial and satellite based wireless communications systems. Terrestrial based wireless communication systems have evolved into wireless wide area network (WWAN) based communication systems. Satellite based wireless communication systems include two-way radio communication systems that allow for voice, text, and data communications. Known systems for these applications generally include two separate and dedicated antennas (a terrestrial communication antenna and a satellite communication antenna) that require a large form factor on modern mobile devices such as user equipment (UE) devices. This problem is increased in UEs that also have Global Navigation Satellite System (GNSS) (e.g., a Global Positioning System (GPS)) receivers because the GNSS also requires another separate and dedicated antenna. In general, GNSS and satellite communication systems need separate antennas because some satellite communication systems have stringent antenna and power handling specifications.

### SUMMARY

Techniques are discussed for a coupling-shared antenna system for satellite signals and terrestrial-network signals.

An example system for terrestrial and satellite communication includes: at least one antenna; an impedance element electrically coupled to a satellite transceiver; and a first switch electrically coupled to the at least one antenna and configured to selectively electrically couple the at least one antenna to one of (1) the satellite transceiver via the impedance element and (2) a terrestrial transceiver; wherein: the at least one antenna has an at least one antenna impedance that is tuned for the at least one antenna to operate at a first frequency band for the terrestrial transceiver; and the impedance element is configured to tune the at least one antenna impedance for the at least one antenna to operate at a second frequency band, different from the first frequency band, for the satellite transceiver.

Another example system for terrestrial and satellite communication includes: a first antenna; a second antenna; an impedance element electrically coupled to the second antenna and a satellite transceiver; and a first switch electrically coupled to the first antenna, wherein the first switch is configured to selectively electrically couple the first antenna to one of (1) a terrestrial transceiver and (2) the second antenna and the satellite transceiver via the impedance element, the first antenna has a first antenna impedance that is tuned to operate at a first frequency band for the terrestrial transceiver, the impedance element is configured to couple the second antenna and the first antenna into a combined antenna having a combined antenna impedance, and tune the combined antenna to operate at a second frequency band, different from the first frequency band, for the satellite transceiver.

Another example system for terrestrial and satellite communication includes: an antenna; a terrestrial frequency filter electrically coupled to a terrestrial transceiver; a satellite frequency filter electrically coupled to a satellite transceiver; an impedance element electrically coupled to the satellite frequency filter; and a first switch electrically coupled to the antenna, wherein the first switch is configured to selectively electrically couple the antenna to one of (1) the terrestrial transceiver via the terrestrial frequency filter and (2) the satellite transceiver via the impedance element and the satellite frequency filter, the antenna has an antenna impedance that is tuned to operate at a first frequency band for the terrestrial transceiver, and the impedance element is configured to tune the antenna impedance for the antenna to operate at a second frequency band, different from the first frequency band, for the satellite transceiver.

Other devices, apparatuses, systems, methods, features, and advantages of the invention will be or will become apparent to one with skill in the art upon examination of the following figures and detailed description. It is intended that all such additional devices, apparatuses, systems, methods, features, and advantages be included within this description, be within the scope of the invention, and be protected by the accompanying claims.

### BRIEF DESCRIPTION OF THE DRAWINGS

FIG. 1 is a system block diagram of an example of an implementation of a system for terrestrial and satellite communication within a user equipment (UE) in accordance with the disclosure.

FIG. 2 is a system block diagram of an example of an implementation of a system for terrestrial and satellite communication in a UE shown in FIG. 1 in accordance with the disclosure.

FIG. 3 is a system block diagram of an example of an implementation of the system shown in FIG. 1 utilizing two antennas in accordance with the disclosure.

FIG. 4 is a system block diagram of an example of an implementation of a UE utilizing the system shown in FIG. 3 in accordance with the disclosure.

FIG. 5 is a system block diagram of an example of an implementation of the UE and system shown in FIG. 4 utilizing a first switch and a second switch in accordance with the disclosure.

FIG. 6 is a system block diagram of another example of an implementation of the UE and system shown in FIGS. 4 and 5 utilizing the first switch and second switch in accordance with the disclosure.

FIG. 7 is a plot of the return loss versus frequency for a first antenna shown in FIG. 5 operating with a terrestrial transceiver in accordance with the disclosure.

FIG. 8 is a plot of the return loss versus frequency for combined antenna shown in FIG. 6 operating with a satellite transceiver in accordance with the disclosure.

FIG. 9 is a system block diagram of another example of an implementation of a system for terrestrial and satellite communication in a UE in accordance with the disclosure.

FIG. 10 is two plots of the forward gain and input reflection coefficient for a bandpass filter shown in FIG. 9 in accordance with the disclosure.

FIG. 11 is a system block diagram of yet another example of an implementation of a system for terrestrial and satellite communication in a UE in accordance with the disclosure.

FIG. 12 is a system block diagram of another example of an implementation of a system for terrestrial and satellite communication in accordance with the disclosure.

FIG. 13 is a system block diagram of yet another example of an implementation of a system for terrestrial and satellite communication and GNSS reception in accordance with the disclosure.

FIG. 14 is a diagram of an example antenna system including impedance circuitry implemented by an antenna tuner chip or module.

FIG. 15 is a diagram of an example antenna system including a variable capacitor coupled between a second antenna and ground.

FIG. 16 is a diagram of an example antenna system including a variable capacitor coupled between a first antenna and ground.

### DETAILED DESCRIPTION

Techniques are discussed for a coupling-shared antenna for satellite signals (e.g., Global Navigation Satellite System (GNSS) (e.g., a Global Positioning System (GPS)), and satellite communication) and terrestrial-network signals (e.g., cellular network signals). The coupling-shared antenna may be implemented as a system for terrestrial and satellite communication. The system may include at least one antenna, an impedance element, and a switch. The impedance element is electrically coupled to a satellite transceiver and the switch is electrically coupled to the at least one antenna and configured to select and electrically couple the at least one antenna to either a terrestrial transceiver or the satellite transceiver via the impedance element. In this example, the at least one antenna has an at least one antenna impedance that is tuned to operate at a first frequency band for the terrestrial transceiver, and the impedance element is configured to tune the at least one antenna impedance to operate at a second frequency band for the satellite transceiver.

Also discussed is a system for terrestrial and satellite communication that may include a first antenna, a second antenna, an impedance element, and a switch. The impedance element is electrically coupled to the second antenna and a satellite transceiver; and the switch is electrically coupled to the first antenna. In this example, the switch is configured to select and electrically couple the first antenna to either a terrestrial transceiver or the second antenna and the satellite transceiver via the impedance element; the first antenna has a first antenna impedance that is tuned to operate at a first frequency band for the terrestrial transceiver; and the impedance element is configured to combine the second antenna and the first antenna into a combined antenna having a combined antenna impedance, and tune the combined antenna to operate at a second frequency band for the satellite transceiver.

Further, another system for terrestrial and satellite communication is also discussed. The system may include an antenna, a terrestrial frequency filter, a satellite frequency filter, an impedance element, and a switch. The terrestrial frequency filter is electrically coupled to a terrestrial transceiver and the satellite frequency filter is electrically coupled to a satellite transceiver. The impedance element is electrically coupled to the satellite frequency filter and the switch is electrically coupled to the antenna. In this example, the switch is configured to select and electrically couple the antenna to either a terrestrial transceiver via the terrestrial frequency filter or the satellite transceiver via the impedance element and the satellite frequency filter; the antenna has an antenna impedance that is tuned to operate at a first frequency band for the terrestrial transceiver; and the impedance element is configured to tune the antenna impedance to operate at a second frequency band for the satellite transceiver.

Moreover, these examples may include an inductor coupled to a first antenna for satellite communications and selectively coupled to a second antenna. The second antenna may be coupled to a cellular (or other) transceiver when de-coupled from the inductor, and may be de-coupled from the transceiver when coupled to the inductor. In these examples, GNSS and satellite data communications may be selected.

In these examples, the systems discussed may be implemented within a user equipment (UE) such as, for example, a mobile device that includes, for example, a cellular device that is configured to operate as, for example, a Wireless Wide Area Network (WWAN) device that may operate at frequency bands that include 700 MHz, 800 MHz, 900 MHz, 1.8 GHz, 1.9 GHz, 2.1 GHz, 2.6 GHz, and 3.5 GHz, 4G Long Term Evolution (LTE) low band (LB) frequencies of 617 MHz to 960 MHz and middle and high bands (M/HBs) frequencies of 1710 to 2690 MHz, and Wi-Fi® 6 frequencies of 2.4 GHz and 5 GHz. The UE may also include a satellite transceiver configured to operate at, for example, frequency bands that include 1616 MHz to 1626 MHz and a GNSS receiver configured to operate at, for example, GPS L1 at 1575.42 MHz, L2 at 1227.6 MHz, and L5 at 1176.45 MHz. The UE may be additionally or alternatively configured to operate at other bands.

By including both a satellite transceiver and a GNSS receiver in addition to a WWAN transceiver, a UE is capable of sending and receiving person-to-person messages (and maybe voice communication) via satellite communications when the UE is outside of a terrestrial cellular coverage area—e.g., in rural areas with low population density such as, for example, mountains, forests, or deserts, or along coastlines or in offshore locations, e.g., when sailing, boating, or fishing.

As used herein, the terms “user equipment” (UE) is not specific to or otherwise limited to any particular Radio Access Technology (RAT), unless otherwise noted. In general, a UE may be any wireless communication device (e.g., a mobile phone, router, tablet computer, laptop computer, consumer asset tracking device, Internet of Things (IoT) device, etc.) used to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi® networks (e.g., based on IEEE (Institute of Electrical and Electronics Engineers) 802.11, etc.) and so on. Two or more UEs may communicate directly in addition to or instead of passing information to each other through a network.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

The terrestrial transceiver may be a WWAN transceiver that is capable of transmitting and receiving wireless RAT signals utilizing for example, 4G LTE, Fifth Generation (5G) Next Generation (NG) RAN, Wi-Fi® networks, and other terrestrial wireless networks. The satellite transceiver may be a transceiver that is capable of transmitting and receiving satellite communications and may include, or be separate from, a Satellite Positioning System (SPS) (e.g., a GNSS) like the GPS, the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS).

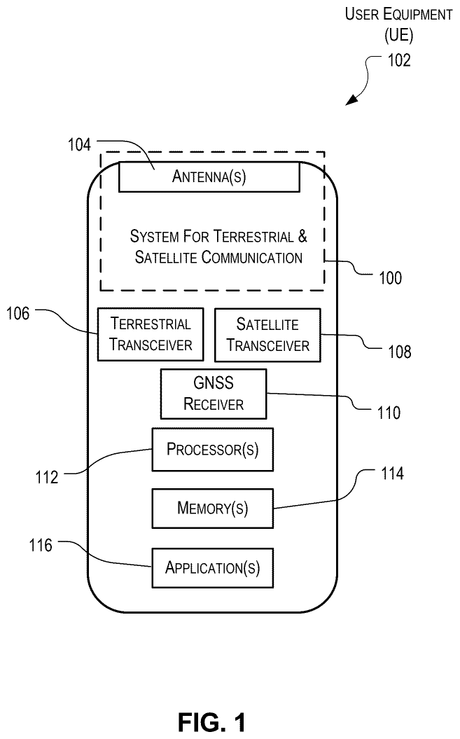

In FIG. 1, a system block diagram of an example of an implementation of a system 100 for terrestrial and satellite communication within a UE 102 is shown. In this example, system 100 includes at least one antenna 104 and the UE 102 may also include a terrestrial transceiver 106, a satellite transceiver 108, a GNSS receiver 110, at least one processor 112 (which may include or be included at least partially within a modem in some configurations), at least one memory 114, and at least one application 116. The UE 102 may be configured to communicate with a terrestrial cellular network and a satellite network via the terrestrial transceiver 106 and satellite transceiver 108, respectively. In this example, the GNSS receiver 110 is configured to receive positional information about the UE 102 from a GNSS network of satellites. As an example, the GNSS receiver 110 may be a separate device, module, and/or component of the UE 102 or may be integrated with, or act in combination with, the satellite transceiver 108.

In general, FIG. 1 provides a generalized illustration of various components, any or all of which may be utilized as appropriate, and each of which may be duplicated or omitted as necessary. The illustrated components, modules, and/or devices of the UE 102 are shown as an example of an implementation of the UE 102 and may include additional (intermediary) components, direct or indirect physical and/or wireless connections, and/or additional networks. Furthermore, components may be rearranged, combined, separated, substituted, and/or omitted, depending on desired functionality.

The UE 102 may comprise and/or may be referred to as a device, a mobile device, a wireless device, a mobile terminal, a terminal, a mobile station (MS), a Secure User Plane Location (SUPL) Enabled Terminal (SET), or by some other name.

Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 102 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi® (also referred to as Wi-Fi®), Bluetooth® (BT), Worldwide Interoperability for Microwave Access (WiMax®), 5G new radio (NR), etc. The UE 102 may support wireless communication using a Wireless Local Area Network (WLAN) which may connect to other networks (e.g., the Internet) using a Digital Subscriber Line (DSL) or packet cable, for example. The use of one or more of these RATs may allow the UE 102 to communicate with an external client and/or allow the external client to receive location information regarding the UE 102.

The UE 102 may include a single entity or may include multiple entities such as in a personal area network where a user may employ audio, video and/or data I/O (input/output) devices and/or body sensors and a separate wireline or wireless modem. An estimate of a location of the UE 102 may be referred to as a location, location estimate, location fix, fix, position, position estimate, or position fix, and may be geographic, thus providing location coordinates for the UE 102 (e.g., latitude and longitude) which may or may not include an altitude component (e.g., height above sea level, height above or depth below ground level, floor level, or basement level). Alternatively, a location of the UE 102 may be expressed as a civic location (e.g., as a postal address or the designation of some point or small area in a building such as a particular room or floor). A location of the UE 102 may be expressed as an area or volume (defined either geographically or in civic form) within which the UE 105 is expected to be located with some probability or confidence level (e.g., 67%, 95%, etc.). A location of the UE 102 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 102 may be configured to communicate with other entities using one or more of a variety of technologies. The UE 102 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi® Direct (WiFi®-D), Bluetooth®, and so on. One or more of a group of UEs utilizing D2D communications may be within a geographic coverage area of a Transmission/Reception Point (TRP) such as one or more basestations. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

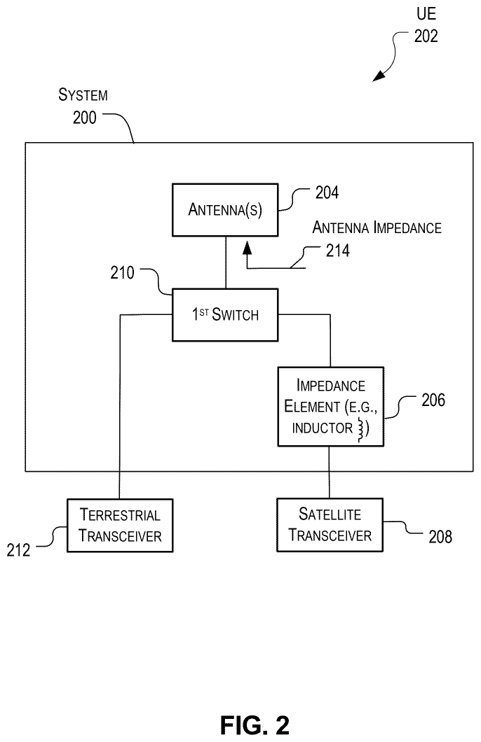

Turning to FIG. 2, a system block diagram is shown of an example of an implementation of a system 200 for terrestrial and satellite communication in a UE 202 (which may be the UE 102 of FIG. 1, and the system 200 may be an example of the system 100). In this example, the system 200 may include: at least one antenna 204; an impedance element 206 electrically coupled to a satellite transceiver 208; and a first switch 210 electrically coupled to the at least one antenna 204 and configured to select and electrically couple the at least one antenna 204 to either a terrestrial transceiver 212 or the satellite transceiver 208 via the impedance element 206. In this example, the at least one antenna 204 has an at least one antenna impedance 214 that is tuned to operate at a first frequency band for the terrestrial transceiver 212; and the impedance element 206 is configured to tune the at least one antenna impedance 214 to operate at a second frequency band for the satellite transceiver 208. As an example, the impedance element may be a variable or fixed inductor. The terrestrial transceiver 212 may be WWAN transceiver such as, for example, a LTE, 4G, or 5G transceiver that is configured to communicate via a wireless cellular network. The satellite transceiver 208 may be, for example, a satellite messaging transceiver that allows for two-way person-to-person messaging.

In an example of operation, the system 200 is configured to switch between utilizing the terrestrial transceiver 212 and the satellite transceiver 208. For example, if the UE 202 is located in an area that is outside of a terrestrial cellular coverage area, the UE 202 will not be able to utilize the terrestrial transceiver 212 to communicate with a wireless cellular network but may still be able to communicate with a satellite-based network via the satellite transceiver 208. In this example, the at least one processor (e.g., the at least one processor 112) of the UE 202 may detect the loss of terrestrial cellular coverage for the UE 202 and then switch the UE 202 from communicating via the terrestrial transceiver 212 to communicating with the satellite network via the satellite transceiver 208 by causing the first switch 210 to switch from electrically coupling the terrestrial transceiver 212 to the at least one antenna 204 to electrically coupling the satellite transceiver 208 to the at least one antenna 204. In this example, since the at least one antenna 204 may be initially tuned to operate at a first frequency band of operation (that corresponds to the frequency band of operation of the terrestrial transceiver 212), the at least one antenna 204 may be re-tuned to a second frequency of operation that corresponds to the frequency band of operation of the satellite transceiver 208. Part of the re-tuning process is done by introducing an impedance to the at least one antenna 204 that will change the resonant frequency of operation of the at least one antenna 204 such that the at least one antenna 204 is retuned to operate at the second frequency of operation. This impedance may be inductive such that the impedance element 206 may be an inductor. In addition to an inductor, the system 200 may include additional tuning circuitry (not shown) that adjusts the resonant frequency of the at least one antenna 204. In this example, the impedance may be a variable impedance that is varied via the additional tuning circuitry, e.g., as controlled by the at least one processor 112.

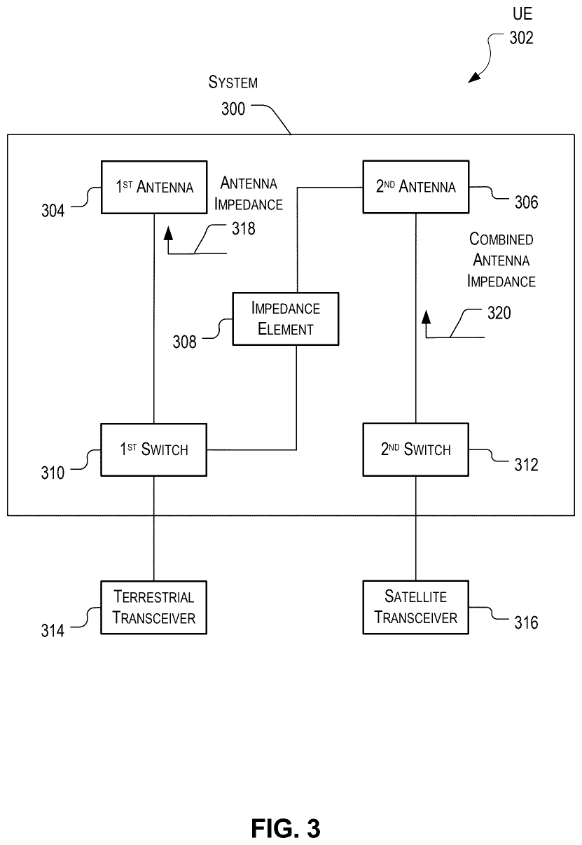

In FIG. 3, a system block diagram is shown of an example of an implementation of the system 300 for terrestrial and satellite communication in a UE 302 (which may be the UE 202 of FIG. 2) utilizing two antennas for the at least one antenna 204 shown in FIG. 2. The system 300 may include a first antenna 304, a second antenna 306, an impedance element 308, a first switch 310, and a second switch 312. In this example, the impedance element 308 is electrically coupled to the second antenna 306 and the first switch 310. The first switch 310 is also electrically coupled to the first antenna 304 and a terrestrial transceiver 314; and the second switch 312 is electrically coupled to the second antenna 306 and a satellite transceiver 316. The first switch 310 is configured to select and electrically couple the first antenna 304 to either the terrestrial transceiver 314 or the second antenna 306 and the satellite transceiver 316 via the impedance element 308.

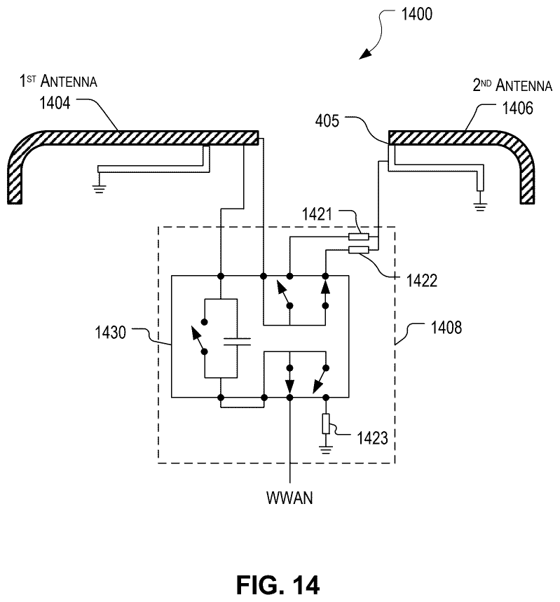

In this example, the first antenna 304 has a first antenna impedance 318 that is tuned to cause the first antenna 304 to operate at a first frequency band for the terrestrial transceiver 314; and the impedance element 308 is configured to combine the second antenna 306 and the first antenna 304 into a combined antenna having a combined antenna impedance 320, and tune the combined antenna to operate at a second frequency band for the satellite transceiver 316. The impedance element 308 may include capacitors and/or inductors that are configured to tune the resonant frequency of the combined antenna by tuning the combined antenna impedance 320. For example, referring also to FIG. 14, an antenna system 1400 includes a first antenna 1404 (which is an example of the first antenna 304), a second antenna 1406 (which is an example of the second antenna 306), and impedance/switching circuitry 1408 (which is an example of the impedance element 308). In this example, the impedance/switching circuitry 1408 comprises a network of switches (controlled by one or more processors (not shown in FIG. 14)), a capacitor, and other impedances 1421, 1422, 1423 (e.g., inductors) in order to select a desired impedance of the impedance/switching circuitry 1408. The impedance circuitry 1408 includes, in this example, an antenna (impedance) tuner 1430, which may be implemented as a chip or a module, for example on a main (PCB) board of the device in which the system 1400 is included. The impedance/switching circuitry 1408 is an example of switches and impedance elements discussed herein, e.g., the switch 210 and the impedance element 206, or the impedance element 308 and the switches 310, 312.

In general, an antenna is said to be resonant if its input reactance is zero and its input impedance is purely resistive allowing for maximum current to flow through the antenna. The reactance of an antenna is the non-resistive component of the impedance in an antenna, arising from the effect of inductance, capacitance, or both and causing an alternating current (AC) in the antenna to be out of phase with the electromotive force that caused the AC current. In general, antennas are tuned to be either resonant or approximately resonant to perform well, where the resonant frequency of the antenna occurs at the point where the capacitive and inductive reactances of the antenna cancel each other out and the antenna appears purely resistive. The resistance being a combination of the loss resistance and the radiation resistance of the antenna.

As such, at resonance, the input impedance of an antenna is, or is approximately, completely resistive (making it easier to match), so that the antenna can receive and transmit all the power it receives from a source, and, therefore, appears to be a purely dissipative load to the source that is electrically coupled to the input/output of the antenna. Therefore, the impedance element 308 is configured to adjust the input impedance of the combined antenna to change the resonant frequency (i.e., tune to the frequency band of operation) of the combined antenna to perform well with the satellite transceiver 316.

In addition to adjusting the input impedance of an antenna, another aspect that affects the resonant frequency of an antenna is the antenna length, which is the length at which the antenna operates most efficiently and radiates the most power. When an antenna is not at its resonant length, some of the RF power is reflected back down the feeding transmission line towards the transmitter of a source, which can damage the transmitter and reduce transmission range. Antennas on UEs may be monopole or planar inverted-F antennas (PIFAs); however, sometimes loop antennas may be utilized. A resonant antenna utilizing either a monopole or a PIFA may be a quarter of a wavelength long, or multiples thereof. If a loop antenna is utilized, the resonance modes of the loop antenna may be at multiple of half-wavelengths.

At these lengths, the antenna may be purely resistive and have zero reactance, allowing the maximum amount of current to flow through it. However, in most wireless applications, antennas are much smaller than a quarter of a wavelength to keep their size down. These antennas may use tuning circuits and ground planes to operate effectively. As a general rule, the larger the antenna, or more specifically the antenna elements, the lower the resonant frequency. However, while larger antennas generally have a lower resonant frequency, the size of an antenna also directly effects its gain, where the effective length of an antenna is proportional to the square root of the gain of the antenna for a particular frequency and radiation resistance.

Due to the limited space for antennas on most mobile devices, it is difficult to accommodate the free-space antenna resonance length in many mobile devices, resulting in antenna bandwidth degradation. Antenna aperture tuners are therefore used to increase the effective antenna bandwidth. However, in satellite communication applications, the input power to the antenna could be up to very high to the point where typical aperture tuners cannot withstand the resulting voltage (i.e., the peak voltage (V_{PK})) across it.

As such, the combination of the first switch 310, second switch 312, and impedance element 308 is configured to extend the effective length of the second antenna 306 by combining it with the first antenna 304 via the impedance element 308 and first switch 310 allowing the satellite transceiver 316 to utilize a “larger” combined antenna when the first switch 310 and second switch 312 are set to select and electrically couple the first antenna 304 with the second antenna 306 via the impedance element 308.

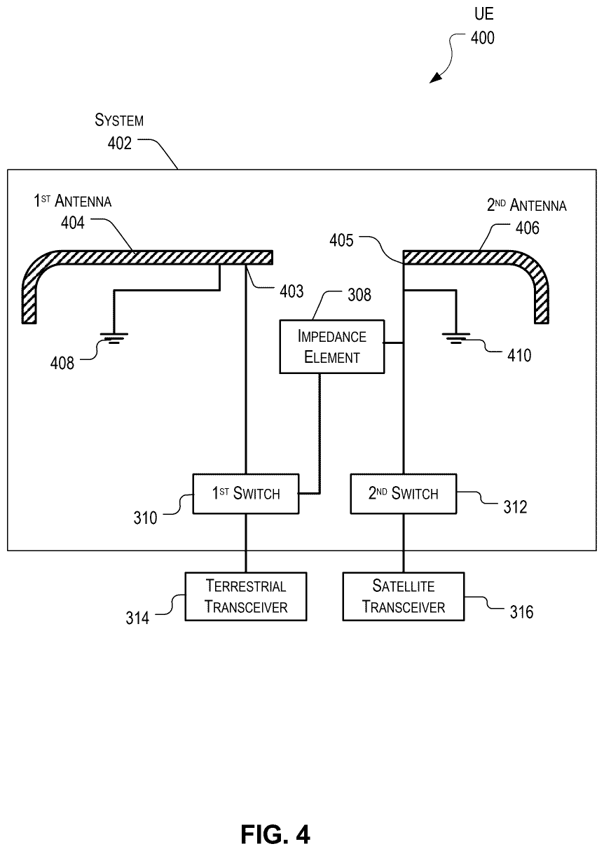

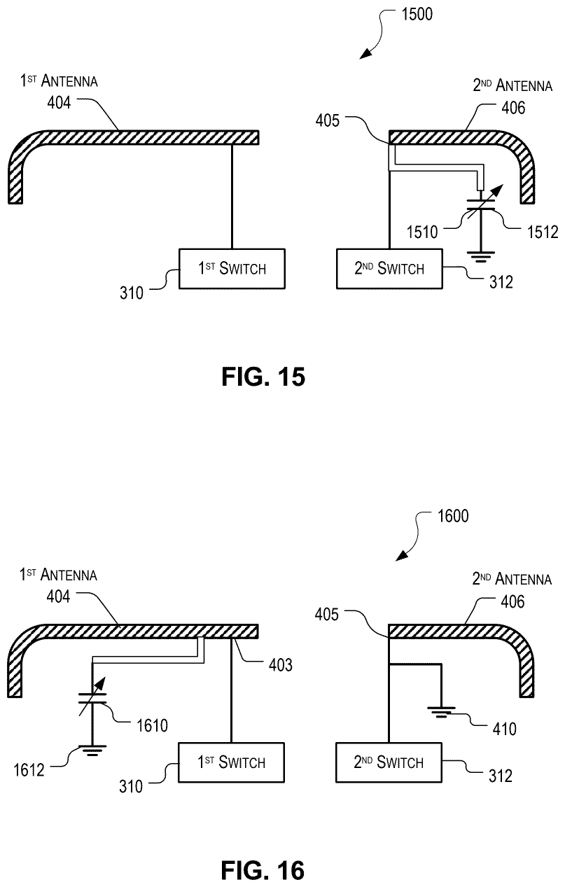

In FIG. 4, a system block diagram is shown of a UE 400 utilizing a system 402 that is an example of the system 300 described in relation to FIG. 3. In this example, the system 300 is shown including the first switch 310, second switch 312, impedance element 308, a first antenna 404, and a second antenna 406. In this example, the first antenna 404 is shown being grounded at a first ground 408 at a first end of the first antenna 404; and the second antenna 406 is shown being grounded at a second ground 410 at a first end of the second antenna 406. Generally, the first ground 408 and second ground 410 may be located near the corresponding feed point (e.g., a first feed point 403 and second feed point 405, respectively) such that each of the antennas 404, 406 acts as a monopole. The first antenna 404 is illustrated having a longer length than the length of second antenna 406. In this example, the first antenna 404 and second antenna 406 may each be a PIFA type of antenna with, for example, an approximate length of 52 mm (i.e., approximately 0.139 λ₀) for the first antenna 404 and an approximate length of 15 mm (i.e., approximately 0.04 λ₀) for the second antenna 406, where the λ₀ is the wavelength at approximately 800 MHz. The shape of the first antenna 404 and second antenna 406 are shown to be approximately conformal with the external geometry of the UE 400, which may be, for example, a smart cellular telephone. Similar to the example shown in FIG. 3, the first switch 310 is electrically coupled to the terrestrial transceiver 314 and the second switch 312 is shown electrically coupled to the satellite transceiver 316. These sizes and shapes are examples only, and other sizes and/or shapes may be used. Referring also to FIGS. 15 and 16, while the antennas 404, 406 are shown connected directly to grounds 408, 410, alternatively the antennas 404, 406 may be connected through a variable capacitor to ground. For example, in an antenna system 1500, the antenna 406 is connected through a variable capacitor 1510 to a ground 1512, and in an antenna system 1600, the antenna 404 is connected through a variable capacitor 1610 to a ground 1612. The variable capacitor may be used to draw power to avoid peak voltage (V_{PK}) that may damage receiver circuitry.

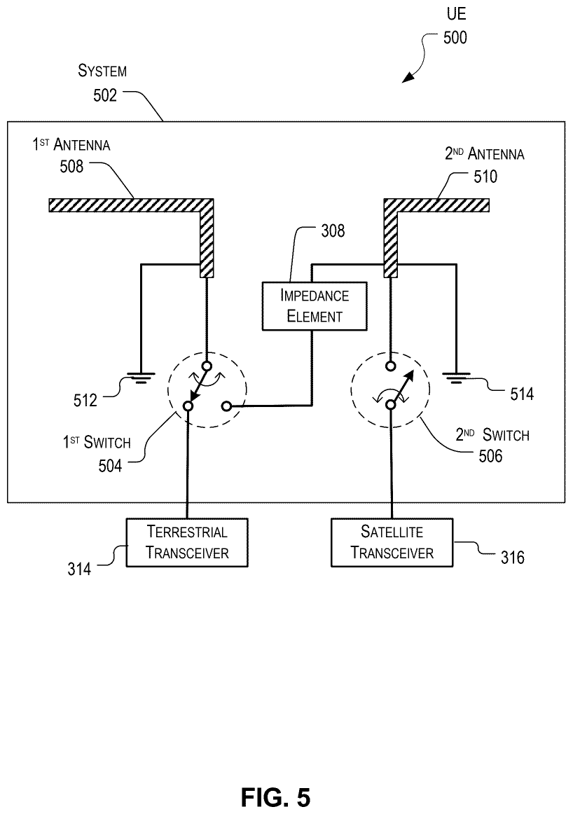

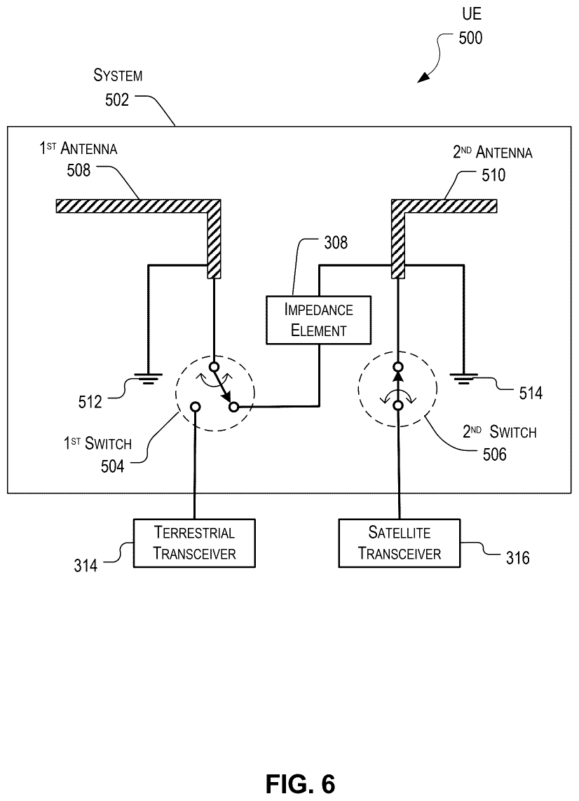

Turning to FIGS. 5 and 6, a system block diagram is shown of the UE 500 and system 502 utilizing the first switch 504 and second switch 506 described in relation to FIGS. 3 and 4. As in FIG. 4, the system 502 includes the first switch 504, the second switch 506, the impedance element 308, a first antenna 508, and a second antenna 510. Similar to FIG. 4, in this example, the first antenna 508 is shown being grounded at a first ground 512 at a first end of the first antenna 508; and the second antenna 510 is shown being grounded at a second ground 514 at a first end of the second antenna 510. In these examples, when the system 502 is configured to transmit or receive with the terrestrial transceiver 314, the first switch 504 is set to electrically couple the first antenna 508 to the terrestrial transceiver 314 and the second switch 506 is set to an open position that deselects the satellite transceiver 316 by uncoupling the satellite transceiver 316 from the second antenna 510. If, instead, the system 502 is configured to transmit or receive with the satellite transceiver 316, the first switch 504 is set to electrically couple the first antenna 508 to the impedance element 308 and the second switch 506 is set to a closed position that selects and electrical couples the satellite transceiver 316 to the combination of the second antenna 510, impedance element 308, and first antenna 508. In this example, by utilizing the combination of the second antenna 510, impedance element 308, and first antenna 508, the effective length of second antenna 510 is increased to support operation at, for example, 1,616MHz to 1,626MHz. which may not be possible with just the second antenna 510 because of the length of the second antenna 510.

It is noted, that in addition to the previous discussion, by placing the second antenna 510 near enough to the first antenna 508 to have mutual coupling effects between the antennas 508, 510, the performance bandwidth of the second antenna 510 may be enhanced.

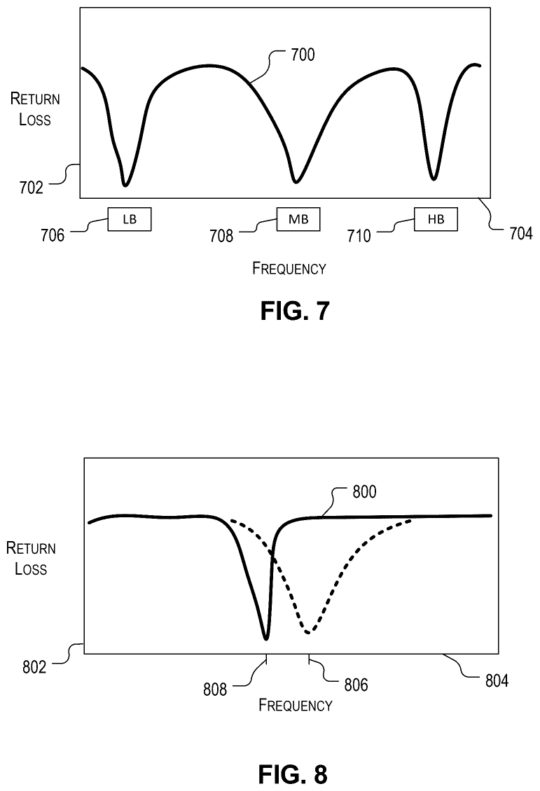

In FIG. 7, a plot 700 of return loss 702 versus frequency 704 is shown for the first antenna 508 operating with the terrestrial transceiver 314. The plot 700 shows that return loss for the antenna has nulls at a low-band (LB) frequency 706, a mid-band (MB) frequency 708, and a high-band (HB) frequency 710, showing that the first antenna 508 is tuned to operate at the LB frequency 706, the MB frequency 708, and the HB frequency 710.

Turning to FIG. 8, a plot 800 of return loss 802 versus frequency 804 is shown for the combined antenna shown in FIG. 6 operating with the satellite transceiver 316. The plot 800 shows that a null of the combined antenna is shifted relative to a null of the second antenna 510 from a high frequency 806 of the second antenna 510 to a low frequency 808 of the combined antenna due to the impedance element 308. As such, the combined antenna is tuned from the original high frequency 806 to the low frequency 808 with the impedance element 308.

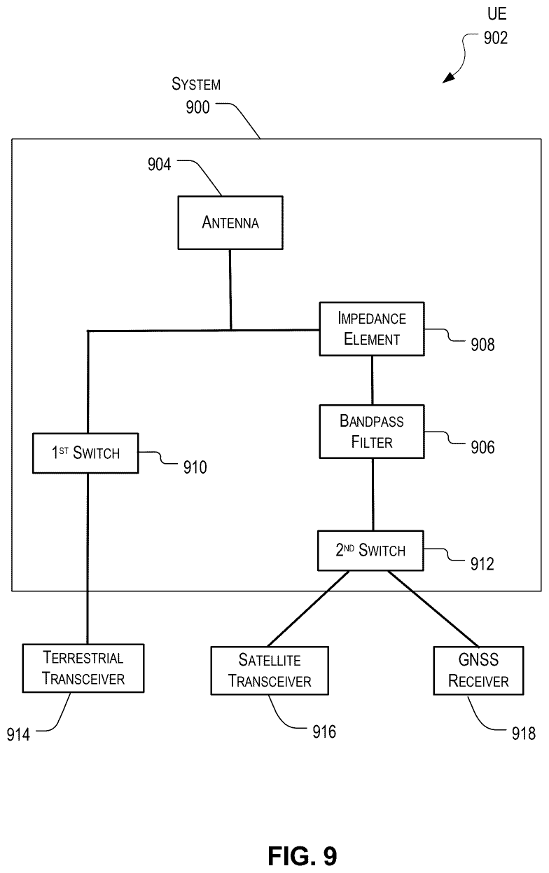

In FIG. 9, a system block diagram is shown of another example of an implementation of a system 900 for terrestrial and satellite communication in a UE 902. The system 900 may include an antenna 904, a bandpass filter 906, an impedance element 908, a first switch 910, and a second switch 912. In this example, the antenna 904 may be a single antenna that is coupled to the first switch 910; the impedance element 908 is electrically coupled to the antenna 904 and the bandpass filter 906; the bandpass filter 906 is also electrically coupled to the second switch 912; the first switch 910 is configured to select and electrically couple a terrestrial transceiver 914 to the antenna 904; and the second switch 912 is configured to select and electrically couple either a satellite transceiver 916 or a GNSS receiver 918 to the antenna 904 through the bandpass filter 906 and impedance element 908. In this example, the antenna 904 may be a WWAN antenna that has been tuned to operate with the terrestrial transceiver 914. By utilizing the combination of the impedance element 908 to retune the antenna 904 and the bandpass filter 906 to eliminate signals outside the frequency range of interest, the satellite transceiver 916 and/or GNSS receiver 918 are capable of utilizing the antenna 904. The bandpass filter 906 is an example, and another form of a satellite frequency filter, e.g., a high-pass filter, may be used.

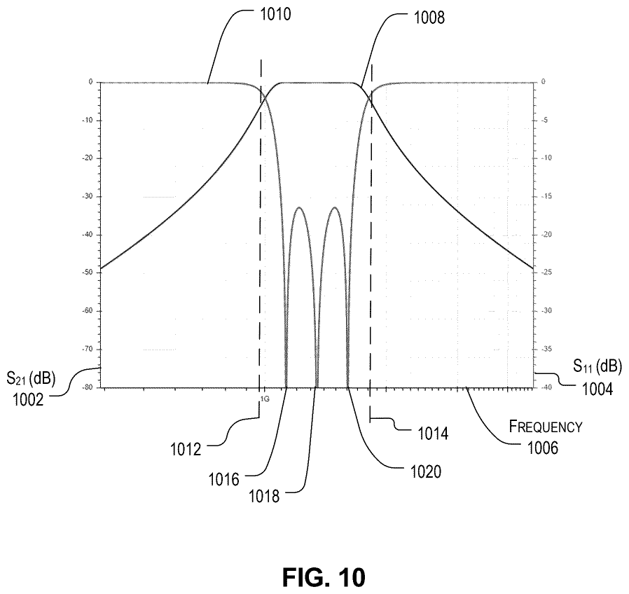

In FIG. 10, two plots are shown of the forward gain 1002 and the input reflection coefficient 1004 versus frequency 1006 for the bandpass filter 906 shown in FIG. 9. In this example, the first plot 1008 represents the forward transmission coefficient (also known as the forward gain) (S₂₁) in decibels (dB) and the second plot 1010 represents the input reflection coefficient (S₁₁) in dB. From the first plot 1008, it is shown that the bandpass filter 906 is passing without significant attenuation (e.g., less than 3 dB attenuation) of the signals that are within a frequency band defined by a low frequency 1012 and a high frequency 1014. From the second plot 1010, it is shown that within this frequency band (i.e., between the low frequency 1012 and the high frequency 1014), the reflection coefficient drops to three nulls 1016, 1018, and 1020.

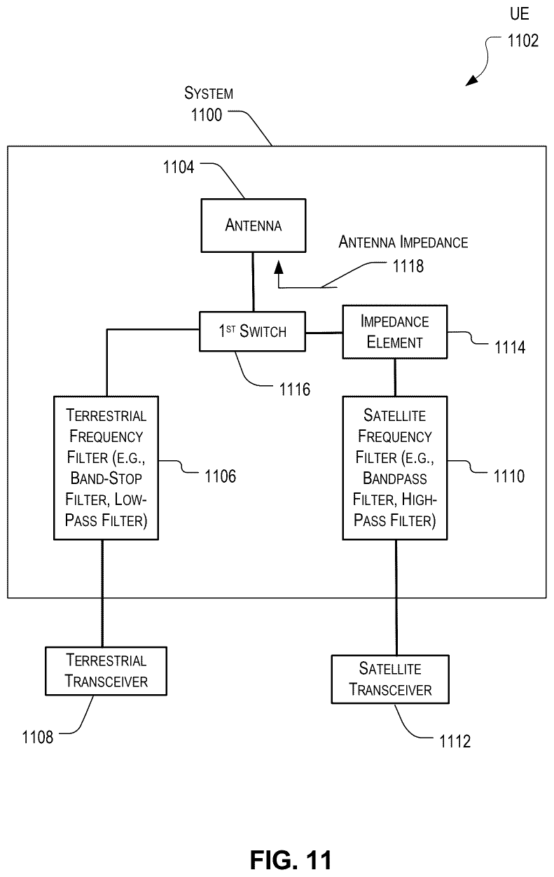

In FIG. 11, a system block diagram is shown of yet another example of an implementation of a system 1100 for terrestrial and satellite communication in a UE 1102. The system 1100 may include: an antenna 1104; a terrestrial frequency filter 1106 electrically coupled to a terrestrial transceiver 1108; a satellite frequency filter 1110 electrically coupled to a satellite transceiver 1112; an impedance element 1114 electrically coupled to the satellite frequency filter 1110; and a first switch 1116 electrically coupled to the antenna 1104. In this example, the first switch 1116 is configured to select and electrically couple the antenna 1104 to either the terrestrial transceiver 1108 via the terrestrial frequency filter 1106 or the satellite transceiver 1112 via the impedance element 1114 and the satellite frequency filter 1110. Further, the antenna 1104 has an antenna impedance 1118 that is tuned to operate at a first frequency band for the terrestrial transceiver 1108, and the impedance element 1114 is configured to tune the antenna impedance 1118 to operate at a second frequency band for the satellite transceiver 1112.

The terrestrial frequency filter 1106 is configured to pass signals in the first frequency band with little attenuation (e.g., less than 3 dB attenuation, such as less than 1 dB attenuation) and to exclude signals that are not within (i.e., that are outside of) the first frequency band (i.e., at least some frequencies outside the first frequency band).

Excluded signals are suppressed by at least a threshold amount, e.g., at least 3 dB. The terrestrial frequency filter 1106 may not exclude all signals outside of the first frequency band, but may exclude signals in the second frequency band. The terrestrial frequency filter 1106 may be a low-pass filter (LPF) that excludes signals above a cut-off frequency or a band-stop filter (notch filter) that excludes signals between two cut-off frequencies. The satellite frequency filter 1110 is configured to pass signals in the second frequency band with little attenuation and to exclude signals that are not within (i.e., that are outside of) the second frequency band. The satellite frequency filter 1110 may not exclude all signals outside of the second frequency band, but may exclude signals in the first frequency band. The satellite frequency filter 1110 may be a high-pass filter (HPF) that passes signals above a cut-off frequency or a bandpass filter that passes signals between two cut-off frequencies (at least a higher of which would be different from a cut-off frequency of a band-stop filter of the terrestrial frequency filter 1106).

The impedance element 1114 may be, for example, an inductor. Further, the system 1100 may include a second switch (not shown) that is electrically coupled to the satellite frequency filter 1110, where the second switch is configured to select and electrically couple the satellite frequency filter 1110 to the satellite transceiver 1112 or a GNSS receiver (not shown).

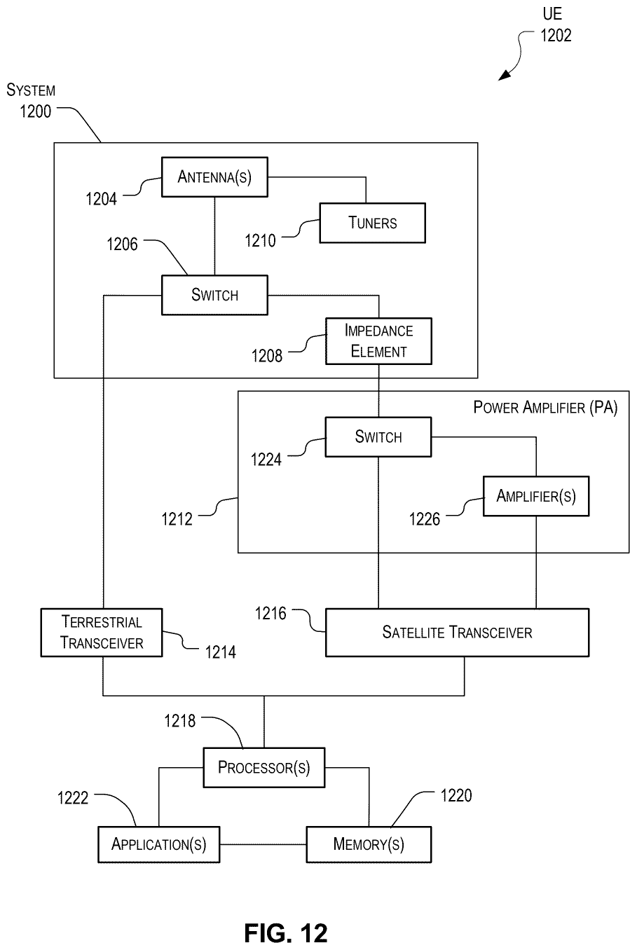

In FIG. 12, a system block diagram is shown of another example of an implementation of a system 1200 for terrestrial and satellite communication within a UE 1202. In this example, the system 1200 may include at least one antenna 1204, a first switch 1206, an impedance element 1208, and tuning circuitry 1210. In addition, the UE 1202 may also include a power amplifier (PA) 1212, a terrestrial transceiver 1214, a satellite transceiver 1216, at least one processor 1218, at least one memory 1220, and at least one application 1222. The PA 1212 may include a second switch 1224 and at least one power amplifier 1226. This example is similar to the previous one already discussed but includes the tuning circuitry 1210 and the PA 1212. In this example, the tuning circuitry 1210 may include a plurality of reactive components that further tune the resonant frequency of the at least one antenna 1204. The second switch 1224 may be utilized to select a reception or transmission path through the PA 1212 where the transmission path may include the at least one power amplifier 1226.

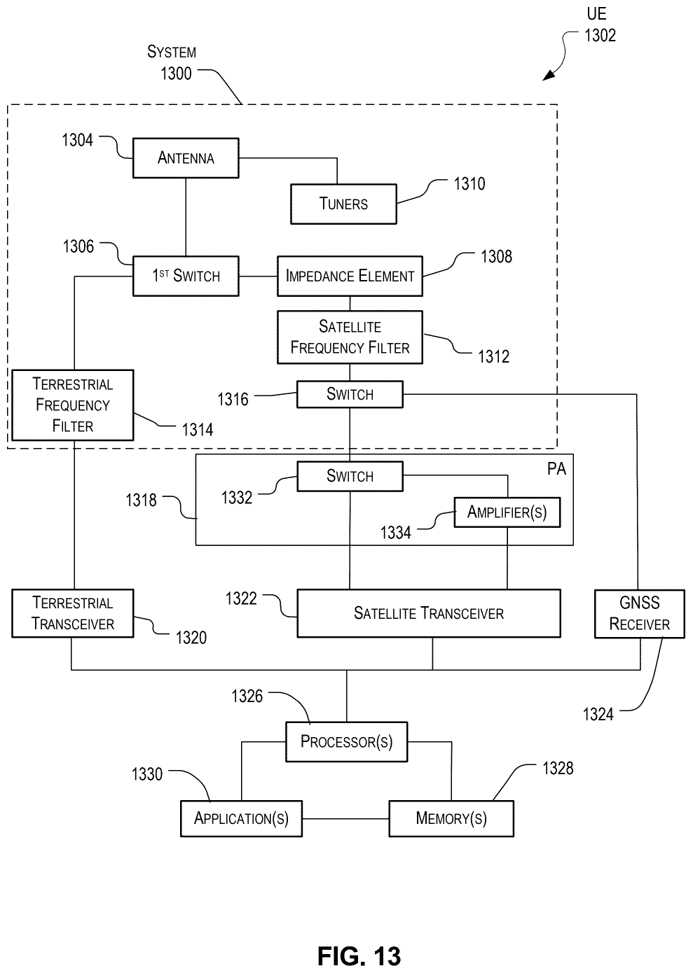

In FIG. 13, a system block diagram is shown of yet another example of an implementation of a system 1300 for terrestrial and satellite communication and GNSS reception within a UE 1302. In this example, the system 1300 may include an antenna 1304, a first switch 1306, an impedance element 1308, tuning circuitry 1310, a satellite frequency filter 1312, a terrestrial frequency filter 1314, and a second switch 1316. In addition, the UE 1202 may also include a PA 1318, a terrestrial transceiver 1320, a satellite transceiver 1322, a GNSS receiver 1324, at least one processor 1326, at least one memory 1328, and at least one application 1330. The PA 1318 may include a third switch 1332 and at least one power amplifier 1334. As discussed previously, in this example, the tuning circuitry 1310 may include a plurality of reactive components that further tune the resonant frequency of the antenna 1304. The third switch 1332 may be utilized to select a reception or transmission path through the PA 1318 where the transmission path may include the at least one power amplifier 1334. The second switch 1316 is utilized to select and electrically couple the PA 1318 (and the satellite transceiver 1322) or the GNSS receiver 1324 to the antenna 1304 via the satellite frequency filter 1312, impedance element 1308, and first switch 1306. In this example, the terrestrial frequency filter 1314 and satellite frequency filter 1312 may be optional to enhance path isolation.

### Implementation Examples

Implementation examples are provided in the following numbered clauses.

Clause 1. A system for terrestrial and satellite communication, the system comprising:
at least one antenna;
an impedance element electrically coupled to a satellite transceiver; and
a first switch electrically coupled to the at least one antenna and configured to selectively electrically couple the at least one antenna to one of (1) the satellite transceiver via the impedance element and (2) a terrestrial transceiver;
wherein:
   the at least one antenna has an at least one antenna impedance that is tuned for the at least one antenna to operate at a first frequency band for the terrestrial transceiver; and
   the impedance element is configured to tune the at least one antenna impedance for the at least one antenna to operate at a second frequency band, different from the first frequency band, for the satellite transceiver.

Clause 2. The system of clause 1, wherein the impedance element is an inductor.

Clause 3. The system of either clause 1 or clause 2, further including
a second switch electrically coupled to the satellite transceiver and configured to selectively electrically couple the at least one antenna to the satellite transceiver,
wherein the first switch is configured to selectively electrically couple the at least one antenna to the satellite transceiver with the second switch electrically coupled to the impedance element.

Clause 4. The system of clause 3, wherein
the at least one antenna includes a first antenna and a second antenna,
the first antenna is electrically coupled to the first switch and has a first antenna impedance that is tuned to operate at the first frequency band for the terrestrial transceiver,
the second switch is configured to selectively electrically couple the second antenna to the satellite transceiver, and
the impedance element is configured to
   couple the second antenna and the first antenna into a combined antenna having a combined antenna impedance, and
   tune the combined antenna to operate at the second frequency band for the satellite transceiver.

Clause 5. The system of clause 4, further including
a third switch that is electrically coupled to the second antenna,
wherein the third switch is configured to selectively electrically couple the second antenna to one of the satellite transceiver and a Global Navigation Satellite System (GNSS) receiver.

Clause 6. The system of clause 5, further including
a satellite frequency filter electrically coupled to the third switch,
wherein the satellite frequency filter is configured to pass signals within the second frequency band and exclude signals that are not within the second frequency band.

Clause 7. The system of clause 6, further including a terrestrial frequency filter electrically coupled to the first switch and the terrestrial transceiver,
wherein the terrestrial frequency filter is configured to exclude signals that are not within the first frequency band.

Clause 8. A system for terrestrial and satellite communication, the system comprising:
a first antenna;
a second antenna;
an impedance element electrically coupled to the second antenna and a satellite transceiver; and
a first switch electrically coupled to the first antenna,
wherein
   the first switch is configured to selectively electrically couple the first antenna to one of
      (1) a terrestrial transceiver and
      (2) the second antenna and the satellite transceiver via the impedance element,
   the first antenna has a first antenna impedance that is tuned to operate at a first frequency band for the terrestrial transceiver,
   the impedance element is configured to
      couple the second antenna and the first antenna into a combined antenna having a combined antenna impedance, and
      tune the combined antenna to operate at a second frequency band, different from the first frequency band, for the satellite transceiver.

Clause 9. The system of clause 8, wherein the impedance element is an inductor.

Clause 10. The system of either clause 8 or clause 9, further including
a second switch that is electrically coupled to the second antenna,
wherein the second switch is configured to selectively electrically couple the second antenna to one of the satellite transceiver and a Global Navigation Satellite System (GNSS) receiver.

Clause 11. The system of clause 10, further including
a satellite frequency filter electrically coupled to the impedance element and the second switch,
wherein the satellite frequency filter is configured to pass signals within the second frequency band and exclude signals that are not within the second frequency band.

Clause 12. A system for terrestrial and satellite communication, the system comprising:
an antenna;
a terrestrial frequency filter electrically coupled to a terrestrial transceiver;
a satellite frequency filter electrically coupled to a satellite transceiver;
an impedance element electrically coupled to the satellite frequency filter; and
a first switch electrically coupled to the antenna,
wherein
   the first switch is configured to selectively electrically couple the antenna to one of
      (1) the terrestrial transceiver via the terrestrial frequency filter and
      (2) the satellite transceiver via the impedance element and the satellite frequency filter,
   the antenna has an antenna impedance that is tuned to operate at a first frequency band for the terrestrial transceiver, and
   the impedance element is configured to tune the antenna impedance for the antenna to operate at a second frequency band, different from the first frequency band, for the satellite transceiver.

Clause 13. The system of clause 12, wherein the impedance element is an inductor.

Clause 14. The system of either clause 12 or clause 13, further including
a second switch that is electrically coupled to the satellite frequency filter,
wherein the second switch is configured to selectively electrically couple the satellite frequency filter to one of the satellite transceiver and a Global Navigation Satellite System (GNSS) receiver.

Clause 15. The system of any of clauses 12-14, wherein the satellite frequency filter is configured to pass signals within the second frequency band and exclude signals that are not within the second frequency band.

Clause 16. The system of any of clauses 12-15, wherein the terrestrial frequency filter is configured to exclude signals that are not within the first frequency band.

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

What is claimed:

1. A system for terrestrial and satellite communication, the system comprising:
at least one antenna;
an impedance element electrically coupled to a satellite transceiver; and
a first switch electrically coupled to the at least one antenna and configured to selectively electrically couple the at least one antenna to one of (1) the satellite transceiver via the impedance element and (2) a terrestrial transceiver;
wherein:
the at least one antenna has an at least one antenna impedance that is tuned for the at least one antenna to operate at a first frequency band for the terrestrial transceiver; and
the impedance element is configured to tune the at least one antenna impedance for the at least one antenna to operate at a second frequency band, different from the first frequency band, for the satellite transceiver.

2. The system of claim 1, wherein the impedance element is an inductor.

3. The system of claim 1, further including
a second switch electrically coupled to the satellite transceiver and configured to selectively electrically couple the at least one antenna to the satellite transceiver,
wherein the first switch is configured to selectively electrically couple the at least one antenna to the satellite transceiver with the second switch electrically coupled to the impedance element.

4. The system of claim 3, wherein
the at least one antenna includes a first antenna and a second antenna,
the first antenna is electrically coupled to the first switch and has a first antenna impedance that is tuned to operate at the first frequency band for the terrestrial transceiver,
the second switch is configured to selectively electrically couple the second antenna to the satellite transceiver, and
the impedance element is configured to
couple the second antenna and the first antenna into a combined antenna having a combined antenna impedance, and
tune the combined antenna to operate at the second frequency band for the satellite transceiver.

5. The system of claim 4, further including
a third switch that is electrically coupled to the second antenna,
wherein the third switch is configured to selectively electrically couple the second antenna to one of the satellite transceiver and a Global Navigation Satellite System (GNSS) receiver.

6. The system of claim 5, further including
a satellite frequency filter electrically coupled to the third switch,
wherein the satellite frequency filter is configured to pass signals within the second frequency band and exclude signals that are not within the second frequency band.

7. The system of claim 6, further including a terrestrial frequency filter electrically coupled to the first switch and the terrestrial transceiver,
wherein the terrestrial frequency filter is configured to exclude signals that are not within the first frequency band.

8. A system for terrestrial and satellite communication, the system comprising:
a first antenna;
a second antenna;
an impedance element electrically coupled to the second antenna and a satellite transceiver; and
a first switch electrically coupled to the first antenna,
wherein
the first switch is configured to selectively electrically couple the first antenna to one of
(1) a terrestrial transceiver and
(2) the second antenna and the satellite transceiver via the impedance element,
the first antenna has a first antenna impedance that is tuned to operate at a first frequency band for the terrestrial transceiver,
the impedance element is configured to
couple the second antenna and the first antenna into a combined antenna having a combined antenna impedance, and
tune the combined antenna to operate at a second frequency band, different from the first frequency band, for the satellite transceiver.

9. The system of claim 8, wherein the impedance element is an inductor.

10. The system of claim 8, further including
a second switch that is electrically coupled to the second antenna,
wherein the second switch is configured to selectively electrically couple the second antenna to one of the satellite transceiver and a Global Navigation Satellite System (GNSS) receiver.

11. The system of claim 10, further including
a satellite frequency filter electrically coupled to the impedance element and the second switch,
wherein the satellite frequency filter is configured to pass signals within the second frequency band and exclude signals that are not within the second frequency band.

12. A system for terrestrial and satellite communication, the system comprising:
an antenna;
a terrestrial frequency filter electrically coupled to a terrestrial transceiver;
a satellite frequency filter electrically coupled to a satellite transceiver;
an impedance element electrically coupled to the satellite frequency filter; and
a first switch electrically coupled to the antenna,
wherein
the first switch is configured to selectively electrically couple the antenna to one of
(1) the terrestrial transceiver via the terrestrial frequency filter and
(2) the satellite transceiver via the impedance element and the satellite frequency filter,
the antenna has an antenna impedance that is tuned to operate at a first frequency band for the terrestrial transceiver, and
the impedance element is configured to tune the antenna impedance for the antenna to operate at a second frequency band, different from the first frequency band, for the satellite transceiver.

13. The system of claim 12, wherein the impedance element is an inductor.

14. The system of claim 12, further including
a second switch that is electrically coupled to the satellite frequency filter,
wherein the second switch is configured to selectively electrically couple the satellite frequency filter to one of the satellite transceiver and a Global Navigation Satellite System (GNSS) receiver.

15. The system of claim 14, wherein the satellite frequency filter is configured to pass signals within the second frequency band and exclude signals that are not within the second frequency band.

16. The system of claim 15, wherein the terrestrial frequency filter is configured to exclude signals that are not within the first frequency band.
